(19) United States
(12) Patent Application Publication
(10) Pub. No.: US 2011/0181751 A1
(43) Pub. Date: Jul. 28, 2011

(54) IMAGING APPARATUS AND IMAGING METHOD

(75) Inventor: Ryuta Mizumori, Kawasaki-shi (JP)

(73) Assignee: CANON KABUSHIKI KAISHA, Tokyo (JP)

(21) Appl. No.: 13/013,670

(22) Filed: Jan. 25, 2011

(30) Foreign Application Priority Data
Jan. 26, 2010 (JP) 2010-014400
Dec. 1, 2010 (JP) 2010-268593

(51) Int. Cl. H04N 5/228

(52) U.S. Cl. 348/222.1; 348/E05.031

(57) ABSTRACT

An imaging apparatus includes an imaging unit configured to generate image data by capturing an object image, a data processing unit configured to generate, by reading predetermined data describing information on a layout of an electronic album from a recording medium and by using the image data generated by the imaging unit, an image representing the image captured by the imaging unit in an album form, a display unit configured to display the image captured by the imaging unit, and a control unit configured to control, in response to completion of a shooting preparation by the imaging unit, the display unit to display the image generated by the data processing unit.

### BACKGROUND OF THE INVENTION

1. Field of the Invention

The present invention relates to an imaging apparatus and an imaging method, and more particularly to an imaging apparatus that has a function of generating an electronic album in parallel with performing an image capturing operation.

2. Description of the Related Art

Japanese Patent Application Laid-Open No. 2004-274500 discusses a technology for generating an electronic album file in a digital still camera while taking a picture by using the digital still camera. The use of the technology discussed in Japanese Patent Application Laid-Open No. 2004-274500 enables the digital still camera to singly generate an electronic album by using image data captured by the digital still camera.

Japanese Patent Application Laid-Open No. 2008-017238 discusses a digital still camera that can arrange a plurality of images on a predetermined template. The digital still camera discussed in Japanese Patent Application Laid-Open No. 2008-017238 can allocate images captured or yet to be captured within an image setting frame preset in the template to display the images. The use of the technology discussed in Japanese Patent Application Laid-Open No. 2008-017238 enables a user to capture images while checking how the images are arranged on the template.

By using the technology, as display functions to check how captured images are arranged in an electronic album when the electronic album is generated by using the images captured by the digital still camera, the following display functions can be acquired:

a first is a function to display a template of an electronic album having an image setting frame on a liquid crystal screen before shooting, and then display captured images (live view images) within the image setting frame; and

a second is a function to display an electronic album screen on which captured images have been fitted on the liquid crystal screen during playback displaying (rec. review displaying) to check the captured images.

However, in a digital still camera with an electronic album generation function assumed based on a configuration of the conventional technology, when the first function is used, a screen of an electronic album having an image setting screen is displayed on a small liquid crystal screen of the digital still camera. Consequently, a display area of captured images within the image setting frame is relatively small, impeding a shooting operation. When a shooting parameter of the camera is changed, checking how the parameter change is reflected on the captured images is difficult.

When the second function is used, a layout on the electronic album is checked at rec. review display timing after shooting. The rec. review displaying means reproducing and displaying of captured images on the display screen for a predetermined period of time (review time) when the captured images are recorded on a recording medium to check the captured images. Thus, when the user does not like a result of registering the captured images in the electronic album, the user may perform correction to delete the registered images from the electronic album. This requires the user to perform useless processing.

### SUMMARY OF THE INVENTION

The present invention is directed to an imaging apparatus that facilitates adjustment of a composition or a parameter by displaying captured images to be easily seen, enables a change to a display state of an electronic album at suitable timing by a simple operation, and enables a user to easily check an album screen to be generated during a shooting operation.

According to an aspect of the present invention, an imaging apparatus includes an imaging unit configured to generate image data by capturing an object image, a data processing unit configured to generate, by reading predetermined data describing information on a layout of an electronic album from a recording medium and by using the image data generated by the imaging unit, an image representing the image captured by the imaging unit in an album form, a display unit configured to display the image captured by the imaging unit, and a control unit configured to control, in response to completion of a shooting preparation by the imaging unit, the display unit to display the image generated by the data processing unit.

According to another aspect of the present invention, an imaging apparatus includes an imaging unit configured to generate image data by capturing an object image, a data processing unit configured to generate, by reading predetermined data describing information on a layout of an electronic album and by using the image data generated by the imaging unit, an image representing the image captured by the imaging unit in an album form, a display unit configured to display a still image for checking after the imaging unit has captured the still image, and a control unit configured to control, while the display unit displays the still image for checking, the display unit to display a predetermined selectable icon or menu to enable displaying the image generated by the data processing unit.

According to yet another aspect of the present invention, an imaging method includes generating image data by capturing an object image, generating, by reading predetermined data describing information on a layout of an electronic album from a recording medium and by using the image data, an image representing the captured image in an album form, displaying the captured image, and controlling, in response to completion of a shooting preparation in the image capturing, displaying of the generated image.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration example of a digital still camera according to a first exemplary embodiment of the present invention.

FIG. 2 illustrates an example of an appearance of the digital still camera according to the first exemplary embodiment of the present invention.

FIG. 3 is a flowchart illustrating an example of a procedure for generating an electronic album according to the first exemplary embodiment of the present invention.

FIG. 4 is a flowchart illustrating another example of a procedure for generating an electronic album according to a second exemplary embodiment of the present invention.

FIG. 5, composed of FIGS. 5A and 5B, is a flowchart illustrating yet another example of a procedure for generating an electronic album according to a third exemplary embodiment of the present invention.

FIG. 6 is a flowchart illustrating still another example of a procedure for generating an electronic album according to a fourth exemplary embodiment of the present invention.

FIGS. 7A to 7E illustrate display examples of liquid crystal screens when a release switch is half-pressed.

FIG. 8 illustrates a display example of a message to warn that there is mismatching in orientation.

FIGS. 9A to 9F illustrate display examples of liquid crystal screens when an electronic album confirmation icon is selected.

FIGS. 10A to 10C illustrate display examples of liquid crystal screens when image data is registered in an electronic album after shooting.

FIGS. 11A and 11B illustrate electronic album data and expressions thereof.

### DESCRIPTION OF THE EMBODIMENTS

Various exemplary embodiments, features, and aspects of the invention will be described in detail below with reference to the drawings.

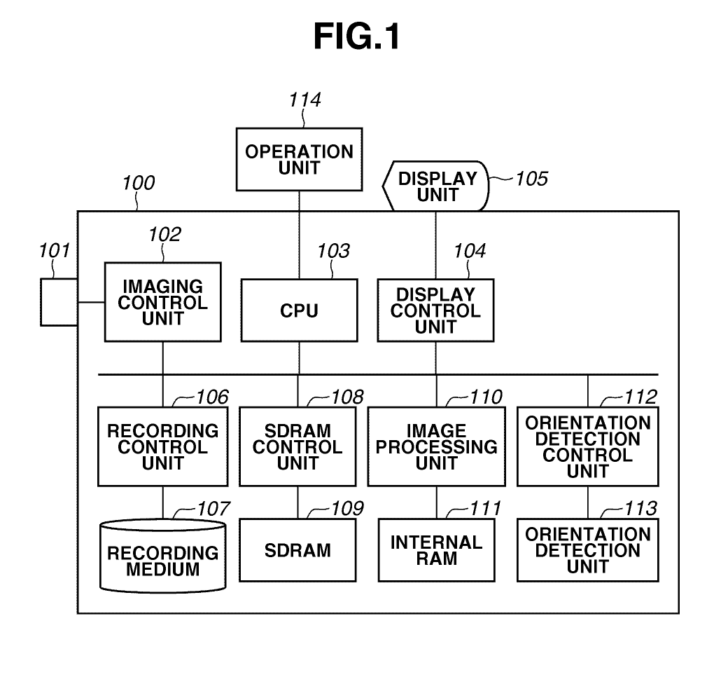

FIG. 1 is a block diagram illustrating a function of a digital still camera 100, which is an imaging apparatus according to a first exemplary embodiment of the present invention. In FIG. 1, an image sensor 101 converts an object image input through a lens into an electric signal to generate an image signal. An imaging control unit 102 converts the electric signal output from the image sensor 101 into digital data to generate image data. A central processing unit (CPU) 103 controls each module, and performs calculation based on information acquired from each module. In the present exemplary embodiment, the CPU 103 performs various device control processes such as data processing to generate display forming data from the image data. A display control unit 104 controls contents displayed on a display unit 105 by controlling an input to or an output from the display unit 105.

The display unit 105 includes a liquid crystal screen and a display processing unit thereof. The display unit 105 generates an image based on data transmitted from the display control unit 104, and reproduces and displays a still image recorded on a recording medium 107. During shooting, the display unit 105 displays a captured image (live view image) by using the digital data from the imaging control unit 102. The display unit 105 displays a menu to a user to serve as a visual interface with the user.

A recording control unit 106 controls reading or writing of various data in the recording medium 107 according to a command from the CPU 103. In the present exemplary embodiment, the recording medium 107 is a detachable recording medium. The user can write a captured still image as digital data by loading the detachable recording medium 107 on the digital still camera 100. The user can write, in addition to the still image, various setting data managed by the digital still camera 100 and layout data for an electronic album. The user can read the written data at appropriate time.

A synchronous dynamic random access memory (SDRAM) control unit 108 controls, according to a command from the CPU 103, temporary recording of data in an SDRAM 109 or reading of data recorded in the SDRAM 109. The SDRAM 109 is used for temporarily storing an internal state of the digital still camera 100 or still image data to be processed. An image processing unit 110 develops or, when necessary, compresses and encodes captured data transmitted from the imaging control unit 102, and converts the captured data into a data format matching a recording system to generate still image data. The image processing unit 110 can generate a captured image.

An internal random access memory (RAM) 111 is used for storing information that the image processing unit 110 internally uses. Thus, direct connection between the internal RAM 111 and the image processing unit 110 enables the image processing unit 110 to execute processing at a high speed.

An orientation detection control unit 112 acquires orientation information of the digital still camera 100 by controlling an orientation detection unit 113 according to a command from the CPU 103. The orientation detection unit 113 includes a gyrosensor, and detects, under control of the orientation detection control unit 112, an orientation of the digital still camera 100 to acquire the orientation information of the digital still camera 100. An operation unit 114 receives an instruction input from the user.

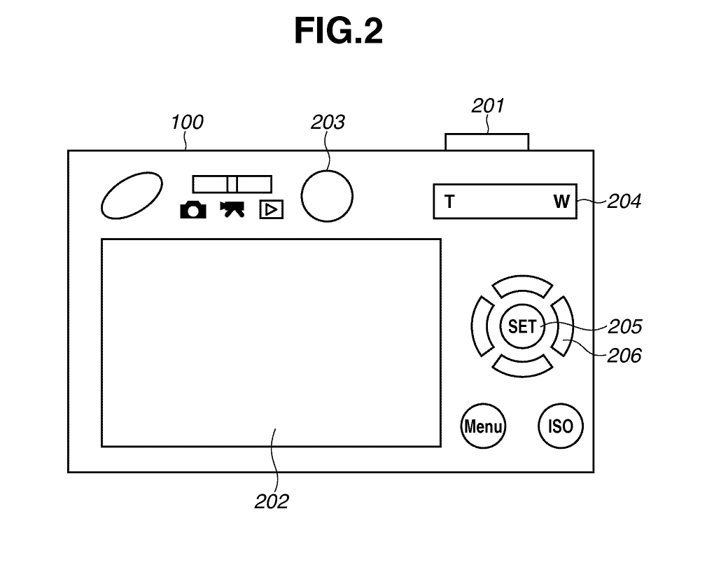

FIG. 2 illustrates an example of an appearance of the digital still camera 100 according to the present exemplary embodiment.

A release switch 201 has a two-stage switch configuration corresponding to pressing operations at two states of a fully-pressed state and a half-pressed state, which indicates an advance notice of an image capturing start. In the present exemplary embodiment, pressing at the first stage is defined as a release switch half-pressed state, and pressing at the second stage is defined as a release switch fully-pressed state. The release switch 201 is a part of the operation unit 114.

A liquid crystal screen 202 displays a screen of a captured image or an electronic album to be generated in a photographing mode. An electronic viewfinder (EVF) 203 displays a screen of the captured image or the electronic album as in the case of the liquid crystal screen 202. Generally, viewing through the EVF 203 to take a picture enables a user to perform shooting where a camera shake is reduced. The liquid crystal screen 202 and the EVF 203 both correspond to the liquid crystal screen of the display unit 105. In the present exemplary embodiment, the liquid crystal screen 202 is a first display device, and the EVF 203 is a second display device. A zoom button 204 is operable to adjust a zoom magnification during shooting, and a playback zoom magnification of a still image during playback. A SET button 205 can play a role of a determination button in menu setting, and select an icon displayed on the liquid crystal screen 202. An up, down, left or right button (arrow key) 206 can select a menu item on a menu screen or move an image position displayed on the liquid crystal screen 202 while maintaining a zoom magnification during playback zooming of the still image. The zoom button 204, the SET button 205, and the up, down, left or right button 206 are all parts of the operation unit 114.

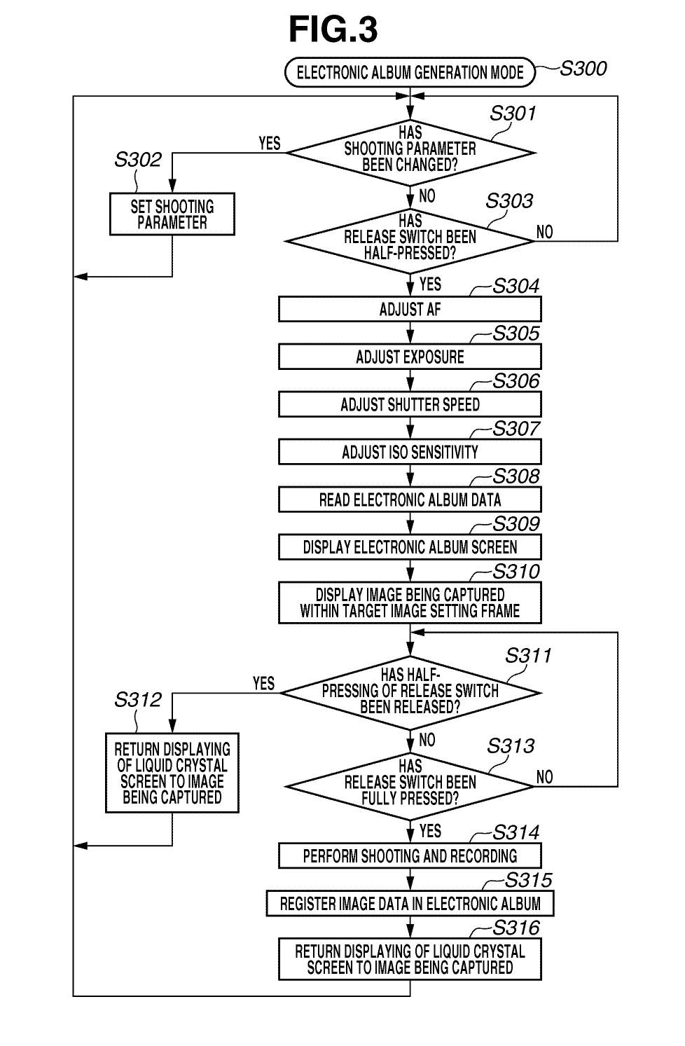

FIG. 3 is a flowchart illustrating an example of a procedure for generating an electronic album while capturing images by the digital still camera 100 according to the present exemplary embodiment. The flowchart illustrates control contents of an operation of the CPU 103, which includes a computer. In step S300, the CPU 103 enters an electronic album generation mode to start processing. In step S301, the CPU 103 determines whether a shooting parameter has been changed. The shooting parameter means a parameter such as an angle of view, a shutter speed, a diaphragm, or International Organization for Standardization (ISO) sensitivity adjustable during the shooting.

When the shooting parameter has been changed (YES in step S301), the processing proceeds to step S302. In step S302, the CPU 103 sets the changed parameter. After step S302, the processing returns to step S301. When no change of the shooting parameter has been detected (NO in step S301), the processing proceeds to step S303.

In step S303, the CPU 103 determines whether the user has half-pressed the release switch 201 to indicate an advance notice of a capturing start. When no half-pressing of the release switch 201 has been detected (No in step S303), the processing returns to step S301. When half-pressing of the release switch 201 has been detected (YES in step S303), the processing proceeds to step S304. In step S304, the digital still camera 100 performs autofocus (AF) adjustment to prepare for shooting. In step S305, the digital still camera 100 similarly performs exposure adjustment to prepare for shooting. In step S306, the digital still camera 100 adjusts a shutter speed. Lastly, in step S307, the digital still camera 100 adjusts ISO sensitivity. Through this processing, the digital still camera 100 completes adjustment based on all the shooting parameters for shooting.

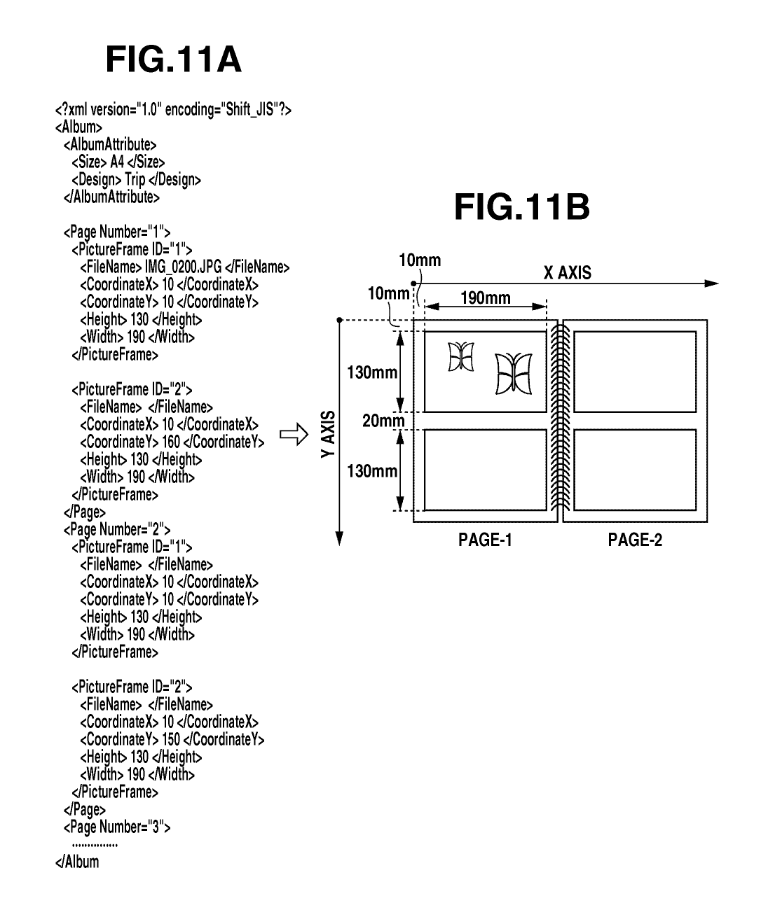

In step S308, electronic album data containing images is read. In the present exemplary embodiment, the electronic album data is assumed to have a data structure described in the Extensible Markup Language (XML) format illustrated in FIG. 11A. As illustrated in an example of FIG. 11A, the entire electronic album is managed as an <Album> element of the first layer. In the present exemplary embodiment, at least an image setting frame for setting image data and display data of an electronic album for managing arrangement information thereof are provided.

The second layer includes an <AlbumAttribute> element. The <AlbumAttribute> element includes <Size> and <Design> elements, and manages information that affects the entire album. After the <AlbumAttribute> element, there is a <page> element in the second layer.

The <page> element has a Number attribute indicating a page number, and literally manages information of a page unit constituting the electronic album. Each <page> element includes a <PictureFrame> element for managing the image setting frame in a page of the electronic album as an element of the third layer. There are <PictureFrame> elements as many as image setting frames defined in the page.

In the present exemplary embodiment, an example where there are two <PictureFrame> elements is described. Each <PictureFrame> element has an ID attribute provided to identify the image setting frame in the page. The <PictureFrame> element manages five elements of <Filename>, <CoordinateX>, <CoordinateY>, <Height>, and <Width> as elements of the fourth layer. In other words, the <PictureFrame> element manages information on a file name of image data set in each image setting frame, and an X coordinate, a Y coordinate, a height, and a width of the image setting frame.

Thereafter, <page> elements for managing the page units in the electronic album are arrayed as many as pages. By using the data of the XML format having such a structure, the digital still camera manages information of the electronic album.

FIG. 11B illustrates an example of a display format (layout) of an electronic album generated by interpreting the electronic album data of the XML format illustrated in FIG. 11A. In each page of the electronic album of A4 size, there are two image setting frames in corresponding coordinates with a left upper portion of the page set as an original point. An image has been set within an image setting frame of page 1.

Referring back to the flowchart of FIG. 3, in step S308, the electronic album data illustrated in FIG. 11A is read. In step S309, the electronic album data read in step S308 is displayed on the liquid crystal screen 202. The electronic album illustrated in FIG. 11B is accordingly displayed on the liquid crystal screen 202. In step S310, for an image setting frame targeted for setting image data, a captured image is displayed within an image setting frame that becomes a next captured image setting target.

Through this processing, the digital still camera 100 can complete, with user's half-pressing of the release switch 201 as a trigger, the shooting preparation by executing shooting condition adjustments such as focus adjustment and exposure adjustment. After the completion of the shooting preparation, a layout of electronic album data being generated is displayed. Thus, upon completion of the shooting preparation of a still image of a shooting target, a state of displaying the captured image on the entire screen can be changed to a state of displaying the captured image within the image setting frame on the layout of the electronic album.

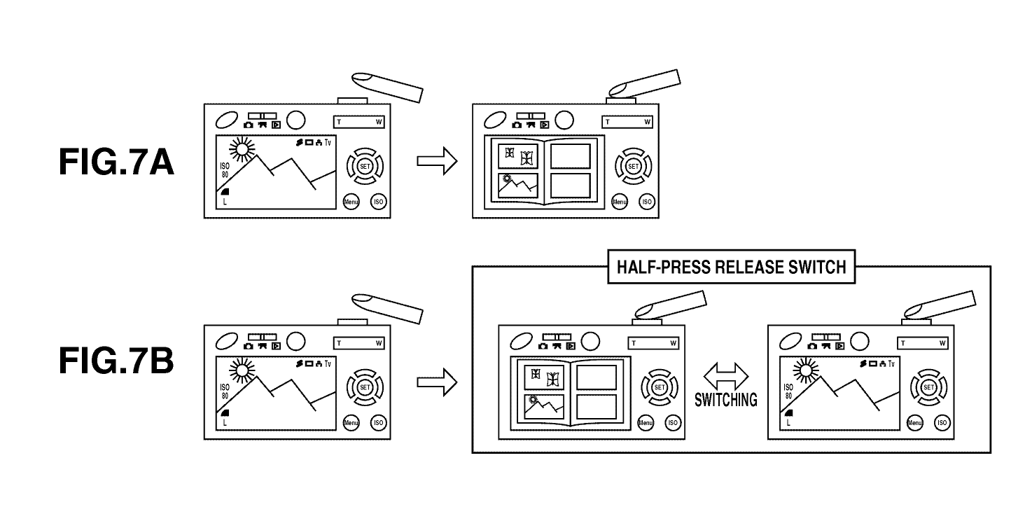

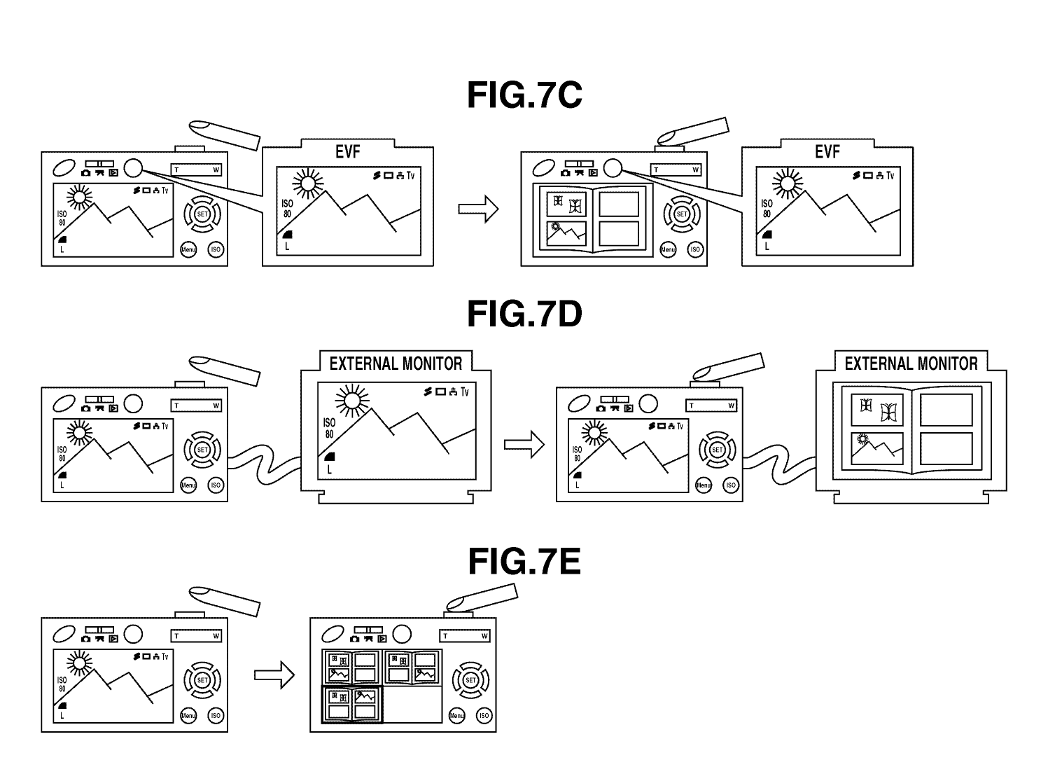

As a result, a finishing image such as how images to be captured are arranged in the electronic album can be presented to the user. Lastly, as illustrated in FIG. 7A, the digital still camera 100 can display the electronic album and the captured image on the liquid crystal screen 202.

Positions where the captured images are arranged are determined according to information described in the electronic album. In the electronic album data illustrated in FIG. 11A, the captured image is displayed within an image setting frame of a <PictureFrameID>=“2”> element in a <pageNumber=1> element where no image data has been set. After completion of this operation, the processing proceeds to step S311.

In step S311, the CPU 103 determines whether user's half-pressing of the release switch 20 determined in step S303 has been released. When the half-pressing has been released (YES in step S311), the processing proceeds to step S312. In step S312, the CPU 103 changes the displaying of the liquid crystal screen from the state of displaying the electronic album set in step S309 to a normal full-screen display state, and then the processing proceeds to step S301. When the half-pressing of the release switch 201 has not been detected, the processing proceeds to step S313.

In step S313, the CPU 103 determines whether the release switch 201 has been fully pressed indicating a capturing start instruction. When the user has fully pressed the release switch 201 (YES in step S313), the processing proceeds to step S314. In step S314, shooting and recording are performed to generate image data. In step S315, the generated image data is registered in the electronic album.

In the present exemplary embodiment, a file name of the image data is described in a <FileName> element in the image setting frame of the <PictureFrameID=“2”> element in the <pageNumber=“1”> element of the electronic album data. In step S316, the CPU 103 returns the displaying of the liquid crystal screen 202 to a normal captured image, and then the processing returns to step S301. When the release switch 201 has not been fully pressed (NO in step S313), the processing returns to step S311.

As described above, according to the present exemplary embodiment, the digital still camera 100 displays, when the release switch 201 is half-pressed during the shooting, the image representing the captured image in an album form on the liquid crystal screen 202. Thus, when adjusting an angle of view or setting shooting parameters, the user can check while watching the normal displaying of the captured image using the entire liquid crystal screen. Moreover, the user can appropriately check contents of the electronic album according to a user's operation at a pre-stage where actual image data is generated by shooting. As a result, unintended reflection of the captured image on the electronic album can be prevented.

The present exemplary embodiment has been directed to the method of switching the displaying of the liquid crystal screen 202 from the captured image to the electronic album by detecting half-pressing of the release switch 201. However, various other methods can be employed.

FIG. 7B illustrates an example where a timer function is set in the CPU 103 so that the CPU 103 can have a function to acquire time information by performing measurement for a predetermined period of time. Thus, an embodiment can be realized where in response to detection of half-pressing of the release switch 201, while the release switch 201 is half-pressed, the displaying on the liquid crystal screen 202 is switched between the electronic album and the captured image at a predetermined time interval. As a result, the contents of the electronic album and the captured image can both be checked.

FIG. 7C illustrates an example of utilizing the electronic viewfinder mounted on the digital still camera 100. In response to detection of half-pressing of the release switch 201, contents of the liquid crystal screen 202 are switched from normal displaying of on-going shooting to displaying of the electronic album, and the EVF 203 continues the normal display state of the captured image. Thus, the contents of the electronic album and the captured image can both be checked at appropriate time. A reverse display method of displaying the captured image on the liquid crystal screen 202 and displaying the screen of the electronic album in the electronic viewfinder can be employed.

FIG. 7D illustrates an example of utilizing an external monitor connected to the digital still camera 100 via a digital interface as a second display device. In response to detection of half-pressing of the release switch 201, contents on the external monitor are changed from normal displaying of the captured image to displaying of the electronic album. The liquid crystal screen 202 continues the normal display state of the captured image. Thus, the contents of the electronic album and the captured image can both be checked at appropriate time. A reverse display method of displaying the captured image on the external monitor and displaying the screen of the electronic album on the liquid crystal screen 202 can be employed. As a result, one of the captured image and the display forming data can be displayed on the liquid crystal screen 202, and the other can be displayed on the external monitor.

FIG. 7E illustrates an example of a method of acquiring, in response to detection of half-pressing of the release switch 201, one image data, and then displaying, by using the image data, a list of results of allocating the image data to a plurality of image setting frames where image data can be set in the electronic album. For example, in the example of the electronic album data according to the present exemplary embodiment illustrated in FIG. 11A, there are three unset image setting frames combining page 1 and page 2. This means that three candidates are presented as illustrated in FIG. 7E. Making the three candidates selectable can provide editing authority to the user. Thus, simple editing can be performed for the electronic album before shooting. A plurality of image setting frames, other than three, can be provided.

In the present exemplary embodiment, in the processing in response to the half-pressing of the release switch 201, as illustrated in steps S304 and S305, the shooting parameters of the AF adjustment and the exposure adjustment are first adjusted, and then the electronic album data is displayed.

In the present exemplary embodiment, as illustrated in FIG. 11A, the example of the data structure of the XML format has been described as the method of describing the electronic album data. However, describing methods other than the XML format can be utilized. For example, a hyper text markup language (HTML) or an extended HTML (XHTML) that is a general markup language to describe a web page can be employed.

A method of utilizing data of a portable document format (PDF: registered trade mark by US Adobe Systems Incorporated) can also be used. The PDF is a file format developed by US Adobe Systems Incorporated to manage electronic books, enabling processing of image data. When data is printed by a printer, a method that utilizes a page descriptive language (PDL) used for instructing the printer to draw a print product can be used. For the page descriptive language, Post Script (registered trademark by US Adobe Systems Incorporated) developed by US Adobe Systems Incorporated) or LIPS used for Canon's printers can be utilized.

Next, a digital still camera according to a second exemplary embodiment of the present invention is described. A configuration of the digital still camera 100 according to the present exemplary embodiment is based on the configuration of the first exemplary embodiment illustrated in the block diagram of FIG. 1 and the conceptual diagram of FIG. 2. As in the case of the first exemplary embodiment, an electronic album can be generated during shooting, and electronic album data is managed in the data structure illustrated in FIG. 11A.

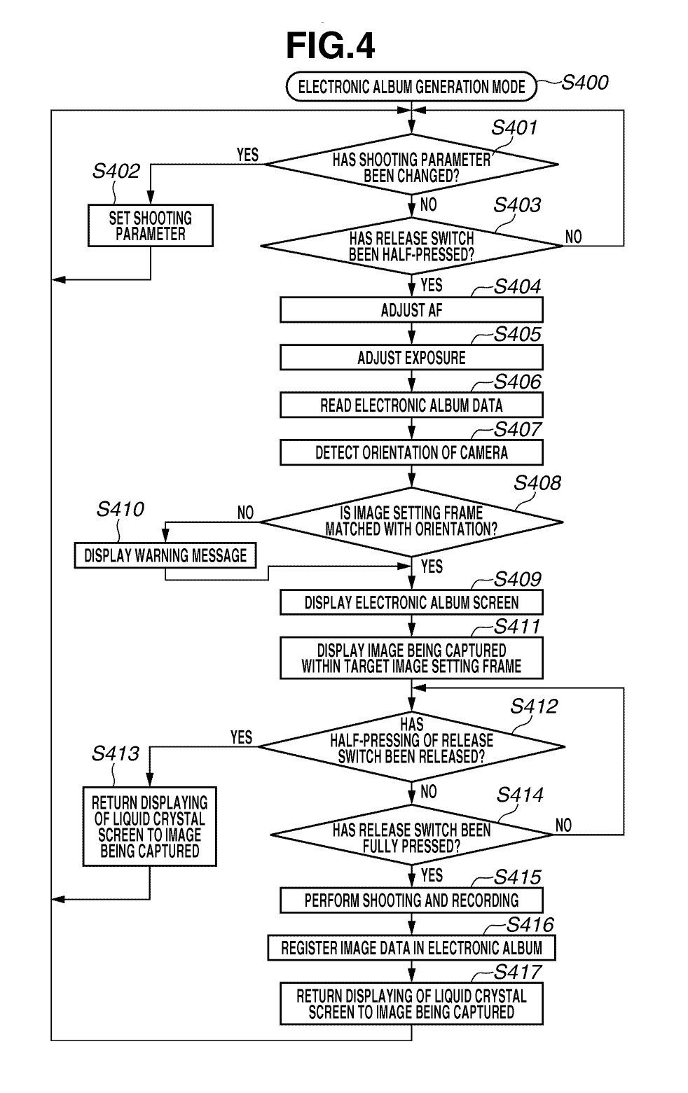

Referring to FIG. 4, an operation of the digital still camera 100 according to the second exemplary embodiment is described. FIG. 4 is a flowchart illustrating an example of a procedure for generating an electronic album by the digital still camera 100 according to the present exemplary embodiment while capturing an image. The flowchart illustrates control contents of an operation of the CPU 103, which includes a computer.

The flowchart of FIG. 4 is basically similar to the flowchart of FIG. 3 illustrating the first exemplary embodiment. Steps S400 to S406 are similar to steps S300 to S308, and steps S411 to 5417 are similar to steps S310 to S316. Characteristic portions of the flowchart of FIG. 4 are steps S407 to S410.

In step S407, an orientation detection unit 113 included in the digital still camera 100 is activated to detect an orientation of the camera, and orientation information on whether the digital still camera 100 is in a portrait orientation or a landscape orientation is acquired. A user sets the digital still camera 100 in the portrait orientation or the landscape orientation during determination of a composition. Assuming such a case, the digital still camera 100 has a function of detecting the orientation of the camera currently engaged in a shooting operation from a detection result of the orientation detection unit 113.

In step S408, in electronic album data read in step S406, whether an image setting frame targeted for next arrangement is a portrait image setting frame or a landscape image setting frame is checked, and compared with the orientation information of the digital still camera 100 itself detected in step S407. When a result of the comparison shows mismatching between an aspect ratio of the image setting frame targeted for next captured image setting in displayed data and the orientation of the digital still camera (NO in step S408), the processing proceeds to step S410. When there is no mismatching (YES in step S408), the processing proceeds to step S409 as in the case of the first exemplary embodiment.

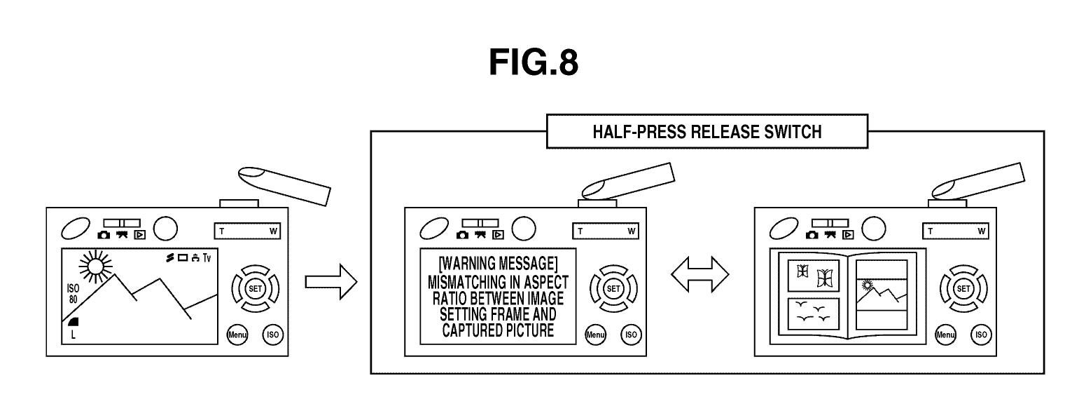

In step S410, as illustrated in FIG. 8, a warning message about the mismatching between the image setting frame and the orientation of the digital still camera 100 is displayed on the liquid crystal screen 202. Thus, the user can be vividly aware of a possibility that an image to be captured may not be reflected well on the electronic album, and motivated to change the orientation of the camera or a shooting composition.

After the warning message has been displayed, the processing proceeds to step S409, and subsequently the electronic album and the captured image in a state where mismatching similarly occurs in portrait and landscape directions between the image setting frame and the digital still camera 100 are displayed on the liquid crystal screen 202 as illustrated in FIG. 8. Thus, after recognition of the mismatching in the portrait and landscape directions through the warning message, the status where the mismatching similarly occurs on the electronic album screen can be actually recognized. As a result, a possibility that the captured image may be reflected in an unintended form on the electronic album can be reduced.

The present exemplary embodiment has been directed to the example where as illustrated in FIG. 8, before the electronic album screen is displayed, the warning message is displayed on the full screen. However, after the electronic album screen is displayed, the warning message can be displayed on the full screen. The warning message can be displayed on the displayed electronic album screen. The image to be captured by the user and the warning message about the mismatching with the electronic album data, described in the present exemplary embodiment, are not displayed any more when the warning becomes unnecessary. In other words, in the example illustrated in FIG. 8, when a change to a matched state with the aspect ratio of the image setting frame made by user's changing of the orientation of the camera to the portrait is detected from the orientation information, the processing is controlled to delete the displayed warning message. Thus, the user can recognize that no mismatching has occurred.

In the first exemplary embodiment, for various display forms of various electronic album data after detection of the half-pressing of the release switch 201 described above referring to FIGS. 7A to 7E, a warning message can be similarly displayed. The time of displaying the warning message can be before or after the electronic album is displayed.

As described above, according to the digital still camera having the electronic album generation function to which the present exemplary embodiment is applied, detecting the half-pressing of the release switch enables switching of displaying on the liquid crystal screen from normal displaying of the captured image to the electronic album screen. Thus, since displaying is similar to the normal screen of ongoing shooting when a setting change of camera parameters during the shooting or effects of the change are checked, the setting change or the effects can be checked by fully using the liquid crystal screen. As a result, inconveniences such as a difficulty of checking the effects of the shooting parameters when the electronic album screen is displayed before shooting preparation can be eliminated. How the image to be captured is applied to the electronic album and an end result can be checked before actual shooting is executed. Thus, when disliking a result reflected on the electronic album, the user can stop the shooting itself. As a result, inconveniences for the user can be eliminated without requiring the user to execute any unnecessary corrections.

Next, a digital still camera according to a third exemplary embodiment of the present invention is described. The first and second exemplary embodiments have been directed to the example where in response to the half-pressing of the release switch 201, the screen of the electronic album data is displayed. However, when the release switch 201 is half-pressed, the camera is set variously according to the shooting parameters. Some users may wish to check adjustment results by the shooting parameters on a large screen using the entire liquid crystal screen 202, and change setting of the shooting parameters to different values to frequently start over.

Thus, the present exemplary embodiment is directed to a method of checking the adjustment results of the shooting parameters by using the entire liquid crystal display screen 202, and then checking a result of reflection on an electronic album by another method.

A configuration of the digital still camera 100 according to the present exemplary embodiment is based on the configuration of the first exemplary embodiment illustrated in the block diagram of FIG. 1 and the conceptual diagram illustrated in FIG. 2. As in the case of the first exemplary embodiment, the electronic album can be generated during shooting. Electronic album data is managed in the data structure illustrated in FIG. 11A.

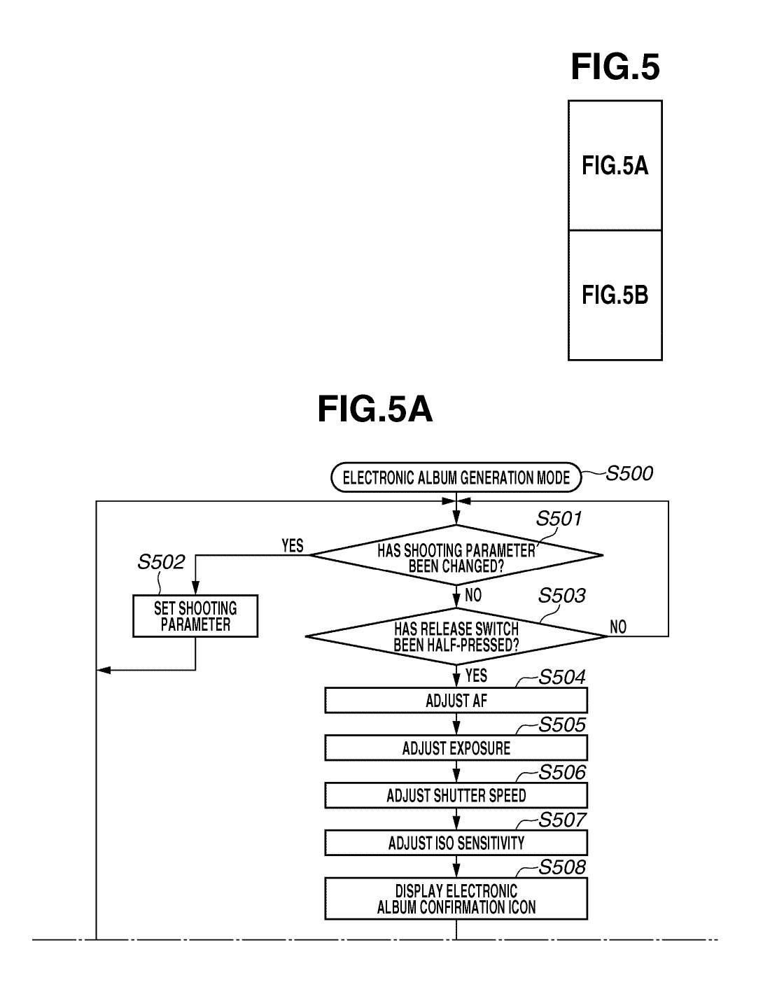

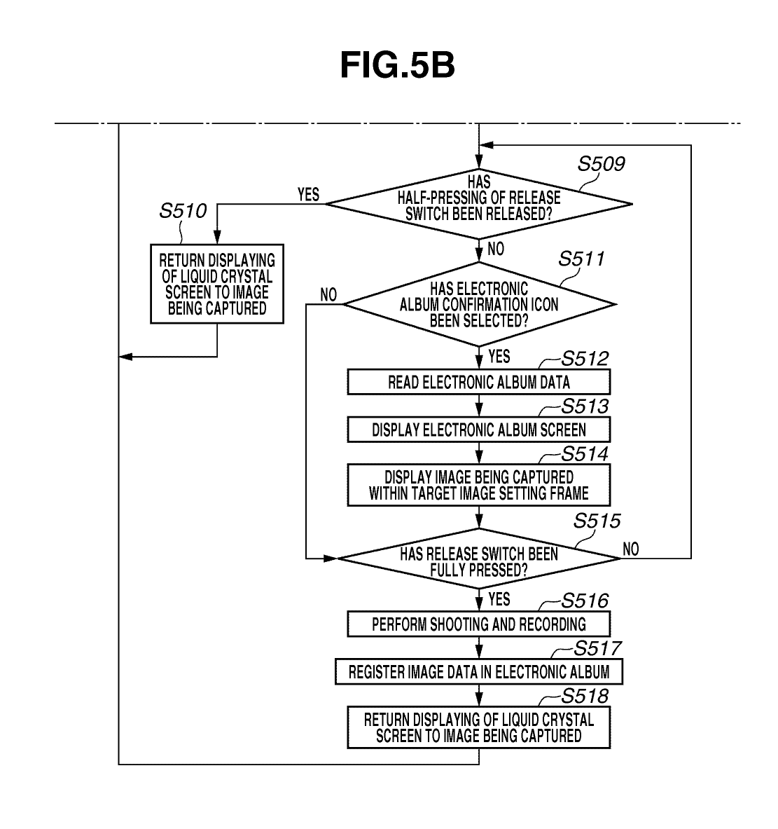

Next, referring to the flowchart of FIG. 5, which is composed of FIGS. 5A and 5B, an operation of the digital still camera 100 according to the third exemplary embodiment is described. FIG. 5 is a flowchart illustrating an example of a procedure for generating an electronic album by the digital still camera 100 according to the present exemplary embodiment while capturing an image. The flowchart illustrates control contents of an operation of the CPU 103, which includes a computer.

In step S500, an entry to an electronic album generation mode starts processing. In step S501, whether the shooting parameter has been changed is determined. The shooting parameter is a parameter such as an angle of view, a shutter speed, an aperture value, or ISO sensitivity, which can be adjusted before shooting.

When a change of the shooting parameter is detected (YES in step S501), the processing proceeds to step S502 to set the changed parameter. After step S502, the processing returns to step S501. When no change of the shooting parameter has been detected (NO in step S501), the processing proceeds to step S503.

In step S503, whether the user has half-pressed a release switch 201 to indicate an advance notice of a shooting start is determined. When no half-pressing of the release switch 201 is detected (NO in step S503), the processing immediately returns to step S501. When half-pressing of the release switch 201 is detected (YES in step S503), the processing proceeds to step S504. In step S504, the digital still camera 100 adjusts AF to prepare for shooting. In step S505, the digital still camera 100 similarly performs exposure adjustment to prepare for shooting. In step S506, the digital still camera 100 adjusts a shutter speed. Lastly, in step S507, the digital still camera 100 adjusts the ISO sensitivity. Through this processing, the digital still camera 100 completes adjustment based on all the shooting parameters for shooting.

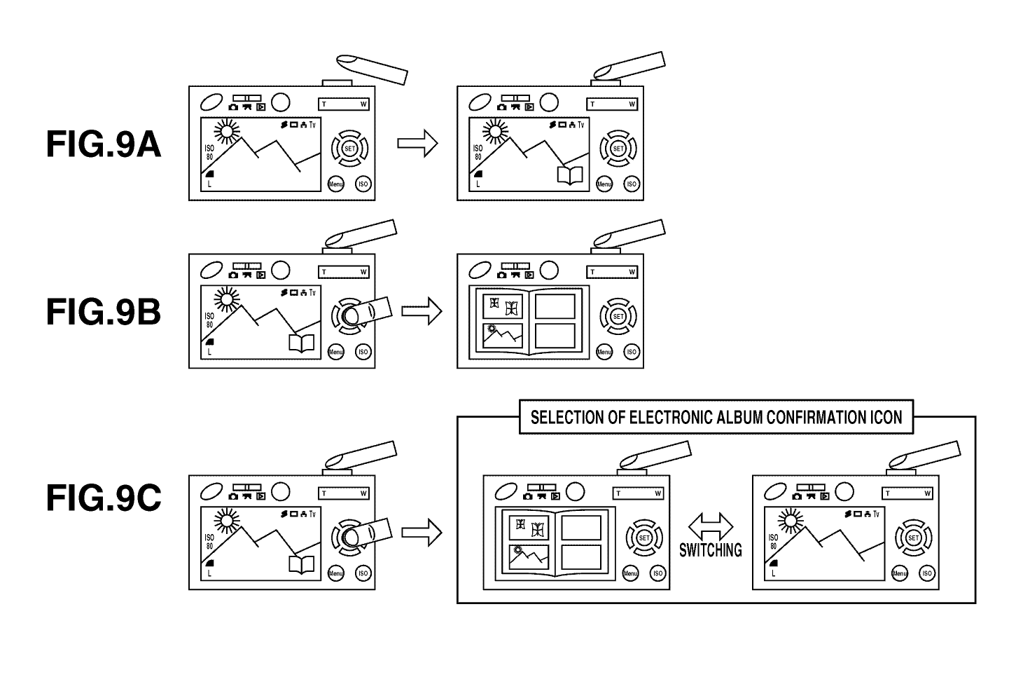

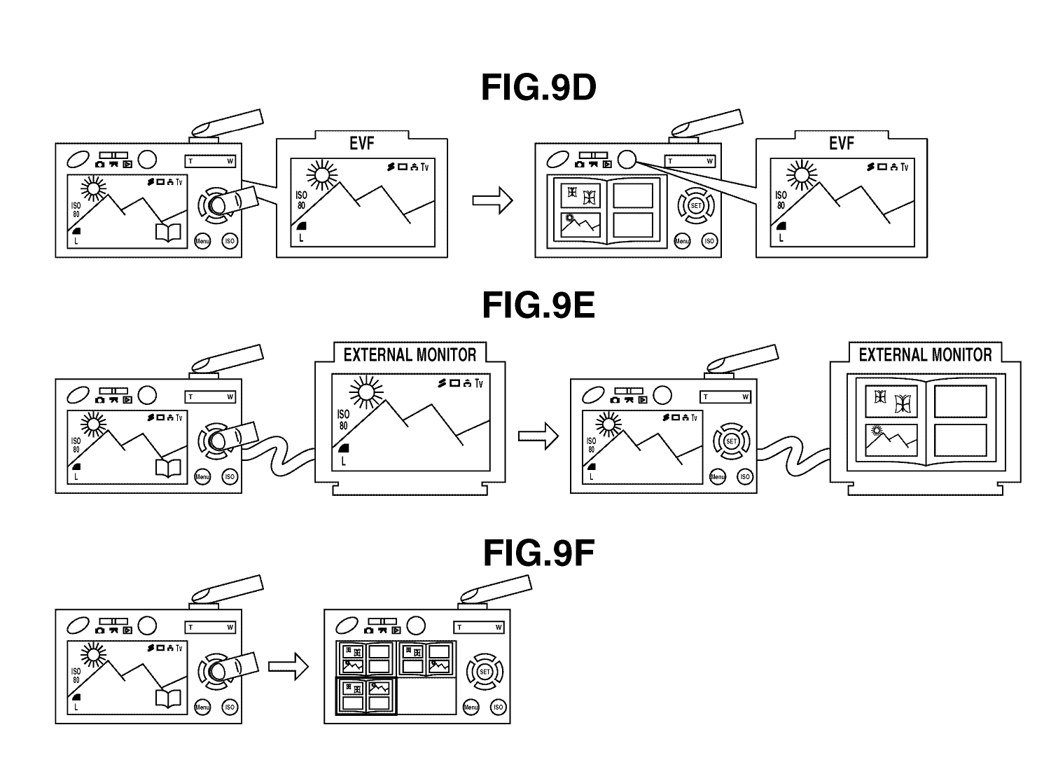

In step S508, with successful shooting preparation as a condition, an electronic album confirmation icon is displayed on the liquid crystal screen 202. The electronic album confirmation icon is an icon of an album shape displayed on a right lower portion of the screen assuming a half-pressed state of the release switch 201 illustrated in FIG. 9A. The electronic album confirmation icon serves to give a notice to the user indicating that shooting of a still image to be added to the electronic album has been prepared, and the user can check how the captured image is arranged on the electronic album. In the present exemplary embodiment, an example of a predetermined icon is described. However, not limited to the icon, a menu to prompt selection of a character or a mark can be used.

In step S509, whether the half-pressed state of the release switch 201 by the user determined in step S503 has been released is determined. When the half-pressed state has been released (YES in step S509), the processing proceeds to step S510. In step S510, the electronic album confirmation icon displayed on the liquid crystal screen 202 in step S508 is set in a non-displayed state to change to normal displaying of an image, and then the processing returns to step S501. When the release of the half-released state of the release switch 201 has not been detected (NO in step S509), the processing proceeds to step S511.

Through this processing, in response to user's half-pressing of the release switch 201, the digital still camera 100 performs adjustment based on a plurality of shooting conditions such as focus adjustment, exposure adjustment, a shutter speed, and the ISO sensitivity, thereby completing the shooting preparation. At this time, the user can check adjustment results of the shooting parameters for the captured image on the liquid crystal screen. To change setting of the shooting parameters, the half-pressing of the release switch 201 is released to start over from step S501. During this period, only the electronic album confirmation icon is displayed without changing to the electronic album screen, and thus checking of the captured image completed for shooting preparation is not prevented.

In step S511, whether the electronic album confirmation icon has been selected is determined. In the present exemplary embodiment, selection of the electronic album confirmation icon means pressing of a SET button 205 in the half-pressed state of the release switch 201 as illustrated in FIG. 9B. When the electronic album confirmation icon has not been selected (NO in step S511), the processing proceeds to step S515. When the electronic album confirmation icon has been selected, the processing proceeds to step S512.

In step S512, the electronic album data illustrated in FIG. 11A is read. In step S513, the electronic album data read in step S512 is displayed on the liquid crystal screen 202. The electronic album illustrated in FIG. 11B is accordingly displayed on the liquid crystal screen 202. In step S514, for an image setting frame targeted for image data setting, the captured image is displayed within an image setting frame targeted for next captured image setting. Thus, according to user selection of the electronic album confirmation icon displayed after completion of the shooting preparation, the state of displaying the captured image on the entire screen can be changed to the state of displaying the captured image within the image setting frame on the layout of the electronic album.

Thus, as illustrated in FIG. 9B, a finishing image such as how the image to be captured is arranged on the electronic album can be presented to the user. After completion of this process, the processing proceeds to step S515.

In step S515, whether the release switch 201 has been fully pressed indicating a capturing start instruction is determined. When the user has fully pressed the release switch 201, the processing proceeds to step S516. Shooting and recording are performed to generate image data. When the user has not fully pressed the release switch 201, the processing returns to step S509. After the shooting in step S516, the processing proceeds to step S517 to register the generated image data in the electronic album.

Then, in step S518, the displaying on the liquid crystal screen 202 is returned to normal captured image displaying, and the processing returns to step S501.

As described above, when the release switch 201 is half-pressed during shooting, the digital still camera 100 according to the present exemplary embodiment performs various adjustments based on the shooting parameters, and displays the electronic album confirmation icon. By selecting the electronic album confirmation icon, the user can display the electronic album data on the liquid crystal screen 202. When setting the shooting parameters, the user can accordingly check while watching the captured image normally displayed on the entire liquid crystal screen 202. Moreover, at a pre-stage of generating actual image data by shooting, an opportunity to appropriately check contents of the electronic album according to a user's operation can be acquired. As a result, unintended reflection of the captured image on the electronic album can be prevented. In the present exemplary embodiment, the electronic album confirmation icon is displayed by detecting half-pressing of the release switch 201, and the displaying on the liquid crystal screen 202 is changed from the captured image to the electronic album. However, other various methods can be employed as in the case of the first exemplary embodiment.

FIG. 9C illustrates an example where a timer function is set in the CPU 103 so that the CPU 103 can have a function to acquire time information by performing measurement for a predetermined period of time. Thus, an embodiment can be realized where in response to selection of the electronic album confirmation icon when the release switch 201 is half-pressed, the displaying on the liquid crystal screen 202 is switched between the electronic album and the captured image at a predetermined time interval. As a result, the contents of the electronic album and the captured image can both be checked.

FIG. 9D illustrates an example of utilizing an electronic viewfinder mounted on the digital still camera 100. In response to selection of the electronic album confirmation icon when the release switch 201 is half-pressed, contents of the liquid crystal screen 202 are switched from normal displaying of on-going shooting to displaying of the electronic album, and the EVF 203 continues the normal display state of the captured image. Thus, the contents of the electronic album and the captured image can both be checked at appropriate time. A reverse display method of displaying the captured image on the liquid crystal screen 202 and displaying the screen of the electronic album in the electronic viewfinder can be employed.

FIG. 9E illustrates an example of utilizing an external monitor connected to the digital still camera 100 via a digital interface as a second display device. In response to selection of the electronic album confirmation icon when the release switch 201 is half-pressed, contents on the external monitor are changed from normal displaying of the captured image to displaying of the electronic album. The liquid crystal screen 202 continues the normal display state of the captured image. Thus, the contents of the electronic album and the captured image can both be checked at appropriate time. A reverse display method of displaying the captured image on the external monitor and displaying the screen of the electronic album on the liquid crystal screen 202 can be employed. As a result, one of the captured image and the display forming data can be displayed on the liquid crystal screen 202, and the other can be displayed on the external monitor.

FIG. 9F illustrates an example of a method of acquiring, in response to selection of the electronic album confirmation icon when the release switch 201 is half-pressed, one image data, and then displaying, by using the image data, a list of results of allocating the image data to a plurality of image setting frames where image data can be set in the electronic album. For example, in the example of the electronic album data according to the present exemplary embodiment illustrated in FIG. 11A, there are three unset image setting frames combining page 1 and page 2. This means that three candidates are presented as illustrated in FIG. 9F. Making the three candidates selectable can provide editing authority to the user. Thus, simple editing can be performed for the electronic album before shooting. A plurality of image setting frames, other than three, can be provided.

Next, a digital still camera according to a fourth exemplary embodiment of the present invention is described. The first to third exemplary embodiments have been directed to the processing of checking the registered contents in the electronic album before the release switch 201 is fully pressed for instructions of shooting. The present exemplary embodiment is directed to an example of controlling displaying an electronic album by using a captured image immediately after the release switch 201 is fully pressed, in other words, after shooting is actually performed.

A configuration of the digital still camera 100 according to the present exemplary embodiment is based on the configuration of the first exemplary embodiment illustrated in the block diagram of FIG. 1 and the conceptual diagram illustrated in FIG. 2. As in the case of the first exemplary embodiment, the electronic album can be generated during shooting. Electronic album data is managed in the data structure illustrated in FIG. 11A.

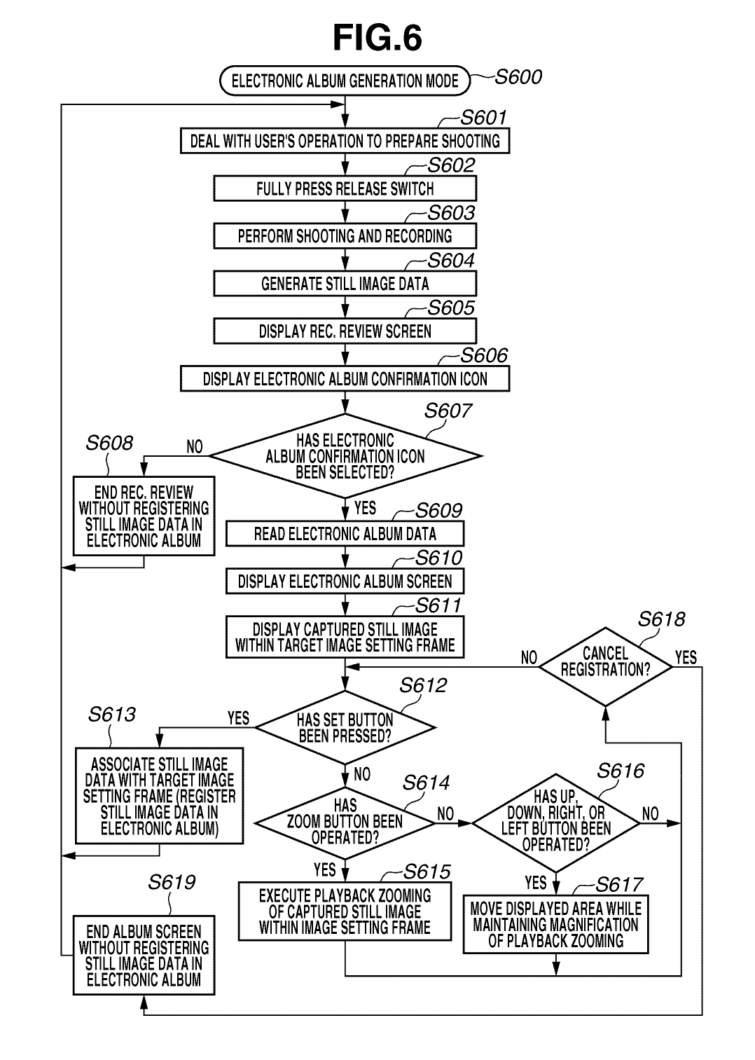

Next, referring to the flowchart of FIG. 6, an operation of the digital still camera 100 according to the fourth exemplary embodiment is described. FIG. 6 is a flowchart illustrating an example of a procedure for generating an electronic album by the digital still camera 100 according to the present exemplary embodiment while capturing an image. The flowchart illustrates control contents of an operation of the CPU 103, which includes a computer.

In step S600, an entry to an electronic album generation mode starts processing. In step S601, a user's operation to prepare shooting is dealt with. The shooting preparation means a general operation such as changing of a focal length, an aperture value, or a shutter speed performed by the user before shooting. After completion of the shooting preparation, actual shooting is performed. In step S602, the user fully presses the release switch 201. In step S603, in response to the full-pressing of the release switch 201, shooting and recording are performed to obtain and record a captured image on a recording medium. In step S604, by using the captured image, still image data is generated as digital data. In step S605, an image regarding the generated still image data is displayed on the liquid crystal screen 202, and a confirmation screen (rec. review screen) to prompt checking of the captured image is displayed. Through this processing, normal still image shooting is completed.

In step S606, an electronic album confirmation icon is displayed. The electronic album confirmation icon is similar to that of the third exemplary embodiment. Needless to say, not limited to the icon, a menu to prompt selection of a character or a mark can be used. Displaying the electronic confirmation icon on the rec. review screen displayed after the full-pressing of the release switch 201 enables a screen change from a rec. review display state of the captured image to a display state of the electronic album. At the rec. review stage, still image data of the captured image is yet to be registered in the electronic album, and hence an opportunity is provided for the user to check an image to be registered in the electronic album. In the present exemplary embodiment, selection of the electronic album confirmation icon also means a state where a SET button 205 is operated on the rec. review screen.

In step S607, whether the electronic album confirmation icon has been selected is determined. When the electronic album confirmation icon has been selected, the processing proceeds to step S609. When the electronic album confirmation icon has not been selected (NO in step S607, for example, a predetermined period of time has elapsed without selection), the processing proceeds to step S608. In step S608, the rec. review is finished without registering the captured still image data in the electronic album. After step S608, the processing returns to step S601 to stand by for next image capturing. The status where the electronic album confirmation icon has not been selected in step S607 is determined by detecting no operation for a fixed period of time using a timer, or detecting an operation of the release switch 201 to shift to next shooting.

In step S609, the electronic album data is selected. The electronic album confirmation icon illustrated in FIG. 11A is read. In step S610, the electronic album data read in step S609 is displayed on the liquid crystal screen 202. The electronic album illustrated in FIG. 11B is accordingly displayed on the liquid crystal screen 202. In step S611, for an image setting frame targeted for image data setting, the still image captured immediately before is displayed within an image setting frame targeted for next captured image setting.

Through this processing, by utilizing a rec. review opportunity, the digital still camera 100 can display the electronic album where the captured image is displayed within the target image setting frame. Depending on whether to select the electronic album confirmation icon during rec. review displaying, an opportunity to select whether to register the captured still image in the electronic album can be provided to the user.

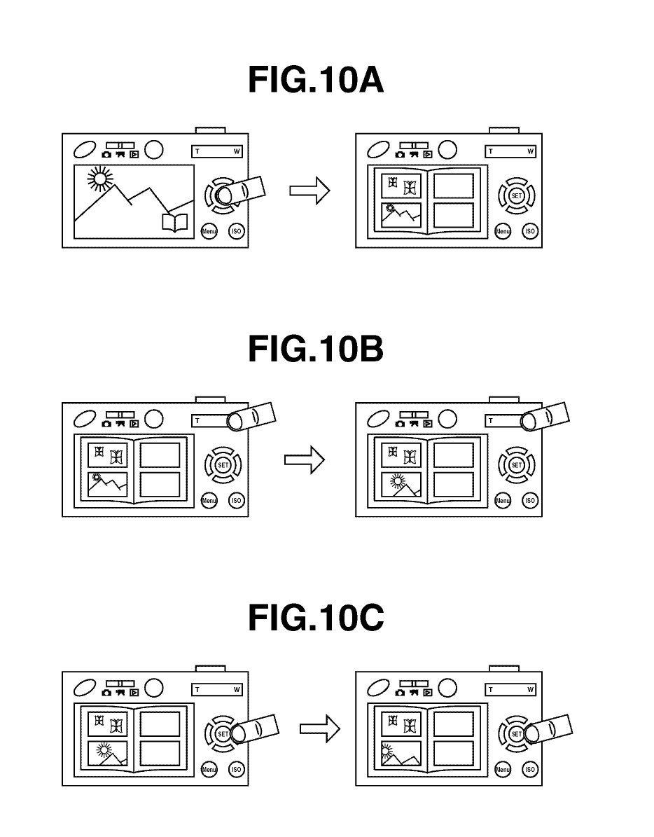

FIG. 10A illustrates a result of the processing in steps S606 to S611. It can be confirmed that in response to an operation of the SET button 205, the electronic album confirmation screen is displayed.

In step S612, whether the SET button 205 has been pressed in the displayed state of the electronic album is determined. When the SET button 205 has been pressed (YES in step S612), the processing proceeds to step S613 to register the electric album including association between the still image data and a target image setting frame. The processing then returns to step S601. When the SET button 205 has not been pressed (NO in step S612), the processing proceeds to step S614.

In step S614, whether a zoom button 204 has been operated is determined. When the zoom button 204 has been operated (YES in step S614), the processing proceeds to step S615 to execute playback zooming of the still image captured within the image setting frame according to the operation of the zoom button 204 while maintaining the electronic album screen. FIG. 10B illustrates a status of a screen change in this case. By operating a telephoto side of the zoom button 204, the image within the image setting frame is playback zoomed. After step S615, the processing proceeds to step S618. When the zoom button 204 has not been operated (NO in step S614), the processing proceeds to step S616 to determine whether an up, down, left, or right button 206 has been operated. When the up, down, left, or right button 206 has been operated, the processing proceeds to step S617 to move an image area displayed within the image setting frame in an operated direction while maintaining a magnification when playback zooming is executed. FIG. 10C illustrates a status of a screen change in this case. By operating the right button of the up, down, left, or right button 206, a still image area displayed while maintaining a magnification is changed. When the image is not zoomed (displayed with a full size), the instruction to move the up, down, left, or right button 206 is invalidated.

After step S617, the processing proceeds to step S618. When the up, down, left, or right button 206 has not been operated (NO in step S616), the processing proceeds to step S618.

In step S618, whether to cancel registration of the still image data in the electronic album is determined. When a user's cancel instruction has been received (YES in step S618), the processing proceeds to step S619. When no cancel instruction has been received (NO in step S618), the processing proceeds to step S612. In step S619, album displaying is finished without registering the captured still image data in the electronic album. Simultaneously, the rec. review is finished. After step S619, the processing returns to step S601 to stand by for capturing a next image.

The processing in steps S614 to S617 means that the image captured within the image setting frame of the electronic album screen is playback zoomed and moved. When the SET button 205 is pressed in step S612 in the playback zoomed state within the image setting screen, then in step S613, an image of an area displayed on the screen is registered in the electronic album. In other words, the still image is trimmed within the range of the image setting frame to be registered in the electronic album.

As described above, by displaying the electronic confirmation icon during the rec. review screen displaying immediately after full-pressing of the release switch 201, the digital still camera 100 according to the present exemplary embodiment can provide an opportunity to check the electronic album to the user. The user can accordingly execute, before the captured image is registered in the electronic album, trimming corresponding to the playback zooming while checking a reflection result on the electronic album. As a result, a registration form of the captured image in the electronic album can be adjusted.

This processing can be performed during a series of capturing operations, and images can sequentially be registered in the electronic album during shooting. This can reduce a burden of correcting registration forms of a plurality of registered images in the electronic album altogether after the shooting.

The present exemplary embodiment has been directed to the example where to enable checking the reflected state of the captured image on the electronic album, the electronic album confirmation icon is displayed in step S606. However, the icon does not always need to be displayed. In other words, after the rec. review in step S605, the processing can proceed to step S609 after an elapse of a predetermined period of time measured by using a timer function.

In the present exemplary embodiment, the playback zooming operation on the electronic album confirmation screen is reflected within the image setting frame, and the result thereof is utilized for registration in the electronic album with trimming. Thus, before actual registration in the electronic album, registration forms of images can be adjusted while being aware of reflection on the electronic album. However, the images can be registered with trimming with clearer intension. For example, in addition to the electronic album confirmation icon displayed in step S606, a dedicated icon such as a “trimming registration icon” can be displayed. Selecting the “trimming registration icon” enables the user to realize image registration premised on trimming.

The units constituting the imaging apparatus and the steps of the imaging method according to each of the exemplary embodiments of the present invention can be realized by operating a program stored in a RAM or a read-only memory (ROM) of a computer. This program and a computer-readable recording medium (storage medium) storing the program are within the present invention.

The present invention can be implemented as, for example, a system, an apparatus, a method, a program, or a recording medium (storage medium). Specifically, the invention can be applied to a system including a plurality of devices, or an apparatus including one device.

The present invention includes a case where software programs for implementing the functions of the exemplary embodiments (in the embodiments, programs corresponding to the flowcharts of FIGS. 3, 4, 5, and 6) are directly or remotely supplied to the system or the apparatus. The invention also includes a case where the computer of the system or the apparatus reads and execute the supplied program code.

Thus, the program code installed in the computer to realize the function processing of the present invention by the computer implements the invention. In other words, the present invention includes the computer programs to implement the function processing of the present invention.

In this case, a form of object code, a program executed by an interpreter, or script data supplied to an operating system (OS) can be employed as long as it has a program function.

As a recording medium (storage medium) to supply the programs, for example, a flexile disk, a hard disk, an optical disk, or a magneto-optical disk can be used. A magneto-optical disk (MO), a compact disc (CD)-ROM, a CD-recordable (R), a CD-rewritable (RW), a magnetic tape, a nonvolatile memory card, a ROM, or a digital versatile disc (DVD) (DVD-ROM or DVD-R) can be used.

As the program supplying method, a method of connecting a web page of the Internet by using a browser of a client computer can be used. The computer program of the present invention or a compressed file containing an automatic installation function can be downloaded from the web page in the recording medium (storage medium) to be supplied.

The program code constituting the program of the present invention can be divided into a plurality of files, and the files can be downloaded from different web pages to be realized. In other words, a World Wide Web (WWW) server that allows a plurality of users to download the program files for realizing the function processing of the present invention is within the present invention.

As another method, the program of the present invention is encrypted to be stored in a recording medium (storage medium) such as a CD-ROM, and distributed to the users. A user who has satisfied predetermined conditions is allowed to download key information for decrypting the encrypted program via the Internet. The user executes the encrypted program by using the key information to install and realize the program in the computer.

The computer executes the read program to realize the functions of the exemplary embodiments. Based on an instruction of the program, an operating system (OS) operating on the computer executes some or all of actual processes, thereby realizing the functions of the exemplary embodiments.

As yet another method, the program read from the recording medium (or storage medium) is written in a memory included in a function extension board inserted into the computer or a function extension unit connected to the computer. Based on the instruction of the program, a CPU included in the function extension board or the function extension unit executers some or all of actual processes, thereby realizing the functions of the exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2010-014400 filed Jan. 26, 2010 and No. 2010-268593 filed Dec. 1, 2010, which are hereby incorporated by reference herein in their entirety.

What is claimed is:

1. An imaging apparatus comprising:
an imaging unit configured to generate image data by capturing an object image;
a data processing unit configured to generate, by reading predetermined data describing information on a layout of an electronic album from a recording medium and by using the image data generated by the imaging unit, an image representing the image captured by the imaging unit in an album form;
a display unit configured to display the image captured by the imaging unit; and
a control unit configured to control, in response to completion of a shooting preparation by the imaging unit, the display unit to display the image generated by the data processing unit.

2. The imaging apparatus according to claim 1, wherein the image generated by the data processing unit includes at least a plurality of image setting frames to set arrangement of a plurality of images, and a plurality of images captured by the imaging unit, and
wherein the control unit causes the display unit to display an image being captured within, among the plurality of image setting frames, an image setting frame targeted for setting.

3. The imaging apparatus according to claim 1, further comprising a release switch having a two-stage switch configuration,
wherein the imaging unit performs, upon detection of first-stage pressing of the release switch, the shooting preparation according to a plurality of shooting parameters, and
wherein the control unit controls, after completion of the shooting preparation according to the plurality of shooting parameters, the display unit to display the image generated by the data processing unit.

4. The imaging apparatus according to claim 2, further comprising an orientation detection unit configured to detect an orientation of the imaging apparatus to output orientation information,
wherein the control unit compares the orientation information acquired from the orientation detection unit with information on an aspect ratio of an image setting frame that becomes a setting target of an image to be captured, and controls the display unit to display a warning message when there is mismatching between the orientation information and the aspect ratio of the image setting frame that becomes the setting target.

5. The imaging apparatus according to claim 1, wherein the display unit displays a predetermined icon or menu in response to completion of the shooting preparation by the imaging unit, and
wherein the control unit controls, when the predetermined icon or menu is displayed and selected by a user, the display unit to display the image generated by the data processing unit.

6. The imaging apparatus according to claim 1, further comprising a generation unit configured to generate electronic album data by registering the image data of the image captured by the imaging unit and the layout of the electronic album in association with each other.

7. An imaging apparatus comprising:
an imaging unit configured to generate image data by capturing an object image;
a data processing unit configured to generate, by reading predetermined data describing information on a layout of an electronic album and by using the image data generated by the imaging unit, an image representing the image captured by the imaging unit in an album form;
a display unit configured to display a still image for checking after the imaging unit has captured the still image; and
a control unit configured to control, while the display unit displays the still image for checking, the display unit to display a predetermined selectable icon or menu to enable displaying the image generated by the data processing unit.

8. The imaging apparatus according to claim 7, further comprising a generation unit configured to generate electronic album data by registering the image data of the image captured by the imaging unit and the layout of the electronic album in association with each other,
wherein, after the still image has been captured and before the generation unit registers the still image in the electronic album, the display unit displays the still image data for checking and displays the predetermined icon or menu, and
wherein the control unit controls, in response to the predetermined icon or menu being selected by a user, the display unit to display the image generated by the data processing unit.

9. The imaging apparatus according to claim 7, further comprising a trimming unit configured to trim, while the display unit displays the image generated by the data processing unit, the still image in response to a predetermined operation unit being operated.

10. An imaging method comprising:
generating image data by capturing an object image;
generating, by reading predetermined data describing information on a layout of an electronic album from a recording medium and by using the image data, an image representing the captured image in an album form;
displaying the captured image; and
controlling, in response to completion of a shooting preparation in the image capturing, displaying of the generated image.

11. An imaging method comprising:
generating image data by capturing an object image;
generating, by reading predetermined data describing information on a layout of an electronic album from a recording medium and by using the image data, an image representing the captured image in an album form;
displaying a still image for checking after the still image has been captured; and
controlling, while the still image is displayed for checking, displaying of a predetermined selectable icon or menu to enable displaying the generated image.
